(19) United States
(12) Patent Application Publication
(10) Pub. No.: US 2008/0202084 A1
(43) Pub. Date: Aug. 28, 2008

(54) DIESEL PARTICULATE FILTER PLEAT DESIGN AND METHOD

(76) Inventors: Michael S. Lynch, Fostoria, OH (US); Gregory E. Ward, Findlay, OH (US)

Correspondence Address: CANTOR COLBURN, LLP, 20 Church Street, 22nd Floor, Hartford, CT, 06103, US

(21) Appl. No.: 11/971,869

(22) Filed: Jan. 9, 2008

Related U.S. Application Data
(60) Provisional application No. 60/884,213, filed on Jan. 9, 2007.

(51) Int. Cl. B01D 46/00

(52) U.S. Cl. 55/493; 156/89.11

(57) ABSTRACT

A ceramic fiber-based filter element having a pleated geometry is provided. The pleated filter element comprises an elongated ceramic filter medium disposed circumferentially around a series of alternately opposing convex saddles along an axis. The alternately opposing convex saddles have root portions and orbicular heads. The root portion of each alternately opposing convex saddle is truncated by an opposing juxtaposition of the orbicular heads of the immediately anterior and posterior convex saddles along the axis. Also provided are methods of forming ceramic fiber-based filter elements having a pleated geometry and forming apparatuses that can be employed to form the same, as well as filter units made using filter elements having a pleated geometry.

This application claims the benefit of U.S. Provisional Application Ser. No. 60/884,213, filed Jan. 9, 2007, the contents of which is incorporated herein by reference.

### BACKGROUND

Exemplary embodiments of the present invention relate to a filter formed from ceramic fibers. More particularly, exemplary embodiments of the present invention relate to a preform for ceramic fiber-based media used in ceramic filters, to methods of configuring and shaping the preform, and to a forming apparatus for forming the same.

Because regulatory agencies have recently mandated the reduction of particulate emissions in diesel engines, there has been increased activity in the development of diesel particulate filters, that is, exhaust gas filters for diesel engines. The role of a typical diesel particulate filter is to trap and remove the particulate components of the diesel exhaust stream, which include diesel soot and aerosols such as ash particulates, metallic abrasion particles, sulfates, and silicates.

There are a variety of diesel particulate filtration technologies on the market. For every diesel particulate filter, two performance aspects are crucial: the filtration efficiency of the system and the ability of the system to provide long-term operation without diminishing the filtration efficiency of the filter and performance of the engine.

The filtration is achieved by a porous structure that allows transmission of the fluid phase but stops or captures diesel particulate matter larger than a threshold particle size. A variety of effective pore sizes are available and, accordingly, filters vary in their filtration efficiencies as a function of particle size of the diesel particulate matter.

Every filter has a finite capacity, and an overfilled diesel particulate filter can damage the engine through excessive exhaust backpressure and can itself be damaged or destroyed. To prevent clogging of the filter pores that causes backpressure to increase and a resultant increase of load on the engine, the trapped particulate material is burned from the filter in the process of regeneration.

Accordingly, it is desirable to provide a geometry for high-porosity ceramic fiber-based media that can be used in a diesel particulate filter, result in less stress to the media, facilitate high filtration efficiency at low backpressure, operate suitably under any type of regeneration system, and increase filter strength and diesel soot loading capacity.

### SUMMARY OF THE INVENTION

In accordance with exemplary embodiments of the present invention, a ceramic fiber-based filter element having a pleated geometry is provided. The pleated filter element comprises an elongated ceramic filter medium disposed circumferentially around a series of alternately opposing convex saddles along an axis. The alternately opposing convex saddles have root portions and orbicular heads. The root portion of each alternately opposing convex saddle is truncated by an opposing juxtaposition of the orbicular heads of the immediately anterior and posterior convex saddles along the axis. The present invention also provides methods of forming ceramic fiber-based filter elements having a pleated geometry and forming apparatuses that can be employed to form the same, as well as filter units made using ceramic fiber-based filter elements having a pleated geometry.

### BRIEF DESCRIPTION OF THE DRAWINGS

FIG. 1 is an illustration of a cross-sectional view of an exemplary embodiment of a filter element having a pleated geometry in accordance with the present invention;

FIG. 2 is a perspective view of the exemplary pleated filter element of FIG. 1;

FIG. 3 is an illustration of a partial cross-sectional view of an exemplary embodiment of a filter element having a pleated geometry that has been formed into a conventional cylindrical configuration in accordance with the present invention;

FIG. 4 is an illustration of an exemplary embodiment of a cylindrical filter unit incorporating a cylindrical filter element having a pleated geometry in accordance with the present invention;

FIGS. 5a-5c illustrate an exemplary embodiment of a method of forming a filter element into a pleated geometry in accordance with the present invention;

FIG. 6a is a partially drawn cross-sectional view of an exemplary embodiment of a forming apparatus in accordance with the present invention;

FIG. 6b is a partial cross-sectional view of the exemplary forming apparatus of FIG. 6a;

FIG. 7 is a cross-sectional view of an exemplary embodiment of a pleating finger in accordance with the present invention;

FIG. 8a is a partially drawn cross-sectional view of an alternative exemplary embodiment of a forming apparatus in accordance with the present invention; and

FIG. 8b is a cross-sectional view of a roller in accordance with the alternative exemplary forming apparatus of FIG. 8a.

### DETAILED DESCRIPTION OF EXEMPLARY EMBODIMENTS

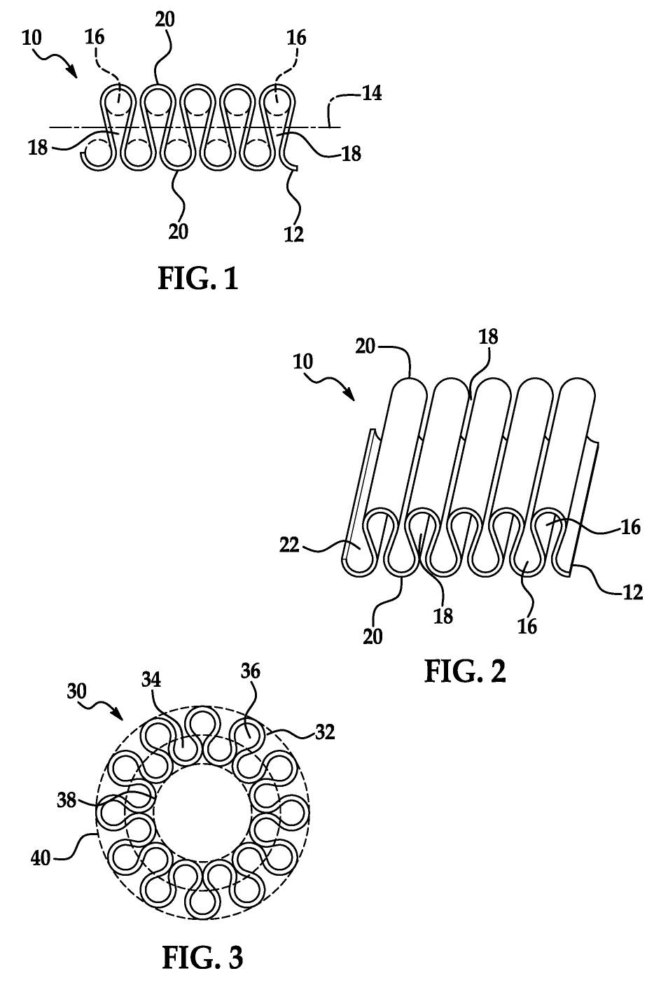

In accordance with an exemplary embodiment of the present invention, FIGS. 1 and 2 illustrate a high-area pleated geometry, indicated generally at 10, for a ceramic-fiber-based web that is suitable for use anywhere a traditional pleated filter element can be used, and can be particularly suitable for use as a filter medium in a diesel particulate filter unit. In the illustrated embodiment, a ceramic filter medium 12 is disposed circumferentially around a shape of a series of alternately opposing convex saddles of generally uniform frequency along a center axis 14. The alternately opposing convex saddles form elongated cylindrical channels 22 having orbicular heads 16 and root portions 18 on both sides of the center axis, as illustrated in FIG. 2. The orbicular heads have substantially similar diameters (indicated by the dotted lines in FIG. 1), alternately opposing crests 20, and define the cross-section of the elongated cylindrical channels. The root portions of each of the alternately opposing convex saddles are truncated by the juxtaposition of the adjacent orbicular heads along the center axis of the immediately anterior and posterior convex saddles.

When ceramic filter media is provided with the advanced, high-area, large radius pleat configurations of the exemplary embodiment described above, several major advantages may be realized over media having a conventional pleat design. Within a given volume print, the media packing density, the media utilization, and the surface area of the filter media will all tend to be greater. Another benefit is that the increased surface area of the filter media can lead to a reduction in flux (flow per unit area), which in turn can increase the filtration capability, thereby allowing a higher flow rate to be utilized in a filter element. The increased mass of the media can also increase the filtration capability. Further, the pleat design can be adequately retained at the elevated temperatures used to regenerate a contaminated filter.

In exemplary embodiments, a pleated geometry as described above can be applied to filter media that relies in part on adsorption and absorption to capture contaminants from a fluid stream, as well as to filter media that performs pore size exclusion filtration. In exemplary embodiments, ceramic fibers, such as fibers of aluminum oxide, zirconium oxide, silicon dioxide, silicon carbide, aluminum nitride, silicon nitride, cordierite, mullite, the fibers described in U.S. Pat. No. 5,087,272, or U.S. Pat. No. 4,873,069, or alumino silicate fibers, or combinations thereof, are suitable for inclusion in exemplary embodiments of filter media in accordance with of the present invention. In exemplary embodiments, the ceramic fibers can be mixed with a portion of cellulosic fibers. A non-limiting example of a type of cellulose fibers that can be mixed with ceramic fibers is papermaking fibers. Because they can remain in the web throughout the pleating process, the cellulose fibers can contribute to the flexibility of the web during the pleating process. In exemplary embodiments, the web may be heat-treated subsequent to or during pleating thereof to drive off the cellulosic fibers.

In exemplary embodiments, ceramic fiber-based filter media having a pleated geometry in accordance with the above description may be formed into a planar element having a pleated preform, such as shown by the example filter medium illustrated in FIG. 2. These exemplary embodiments can be suitable for use, for instance, in a filter unit designed to incorporate a pleated flat panel filter element. In alternative exemplary embodiments, ceramic fiber-based filter media having such a pleated geometry can also be sufficiently flexible to be formed into a conventional cylindrical configuration, such as indicated generally by 30 in the example illustrated in FIG. 3. In the exemplary configuration shown in FIG. 3, a ceramic filter medium 32 comprises a series of alternately opposed convex saddles that are curved into a plurality of approximately radially extending pleats to form a cylindrical pleated filter element 30 having an inner periphery 38 and an outer periphery 40. The lengthwise edges of the pleated filter element can be sealed to each other along a seam by conventional means, such as ultrasonic welding, to retain the pleated filter element in the cylindrical form. In another alternative exemplary configuration, the series of alternately opposed convex saddles in ceramic fiber-based filter media having such a pleated geometry may be formed into a plurality of approximately radially extending pleats that are curved so as to have a spiral arrangement. In any event, ceramic fiber-based filter media having such a pleated geometry can be exceptionally dimensionally stable in whatever geometry it may be arranged and, therefore, can be incorporated into any housing that is suitable for use in the anticipated use environment of a final filter unit, such as, for example, housings made of metal and/or other materials.

In the exemplary embodiment illustrated in FIG. 3, the radially extending pleats of the filter medium comprise alternately opposed inwardly radiating convex saddles 34 and outwardly radiating convex saddles 36 that are spaced from one another at a uniform frequency. Thus, an inwardly radiating convex saddle includes a pleat that extends from its root portion to its crest in the radial direction from the outer periphery to the inner periphery of the cylindrical filter element, and an outwardly radiating convex saddle includes a pleat that extends from its root portion to its crest in the radial direction from the inner periphery to the outer periphery of the cylindrical filter element. The exemplary pleated filter element may be adapted to, for example, accommodate, in a first operational mode, a fluid flow in a first radial direction and, in a second operational mode, a fluid flow in a second radial direction, opposite to the first radial direction.

Referring now to the exemplary embodiment illustrated in FIG. 4, a filter module, indicated generally by 100, includes a cylindrical pleated filter element 110 that comprises a ceramic fiber-based web formed into a plurality of pleats in accordance with the geometry described above. The plurality of pleats of filter element 110 includes alternately opposing inwardly radiating convex saddles 112 and outwardly radiating convex saddles 114. The alternately opposing convex saddles form a plurality of radially extending elongated channels 116 that run in an axial direction to the cylindrical structural frame of the filter module.

In the present exemplary embodiment, the structural frame of filter module 100 includes a cylindrical core 118 that may be axially positioned within the inner periphery of the cylindrical filter element. This frame may be formed, for example, using a ceramic injection molding or casting process. The cylindrical core supports the inner periphery of the filter element against forces in the radial direction and also helps to provide the filter element with axial strength and rigidity against bending. Core openings 126 are formed through the cylindrical core to permit the passage of fluid. A cylindrical outer cage (not shown) may be axially positioned about the outer periphery of the cylindrical filter element.

In exemplary embodiments, the cylindrical core may be of conventional design and may be made of any material having sufficient strength and which is compatible with the fluid being filtered. The outer cage may comprise a conventional design and include outer cage openings formed therein for the passage of fluid, but can also comprise an alternate design such as an expandable mesh sleeve, a porous extruded tube, or a wrap consisting of cord, woven or non-woven material. The material of which the outer cage is made can be selected based on the fluid being filtered and the filtering conditions in exemplary embodiments.

As illustrated in the exemplary embodiment of FIG. 4, end caps 120, 122 may be attached to the ends of the filter module. The end caps may, for example, be attached to the filter element, and they may also be attached to the cylindrical core or the outer cage. Conventional techniques, such as by use of an epoxy, thermal bonding, or spin welding, can be used to attach the end caps to the components of the filter module. The material of which the end caps are formed and their shape can be selected in accordance with the filtering conditions and the materials of the members.

In exemplary embodiments, filter module 100 can be provided in a wide range of parameters. Typical parameters, which are not meant to be limiting, may include a filter module having an outside diameter ranging from about 200 mm to about 325 mm, although modules having diameters upwards of about 400 mm are presently contemplated. A typical inside diameter may be about 25 mm to about 100 mm. A typical filter module height or length may range from about 100 mm to upwards of about 500 mm. The typical filter element may include from about 2 to about 7 layers of depth filter media. The use of multiple media layers can be utilized to increase the soot capacity of a filter module by overcoming the plugging that occurs in the top 20-30% of a single layer media, thereby enabling greater soot penetration and reducing regeneration frequency.

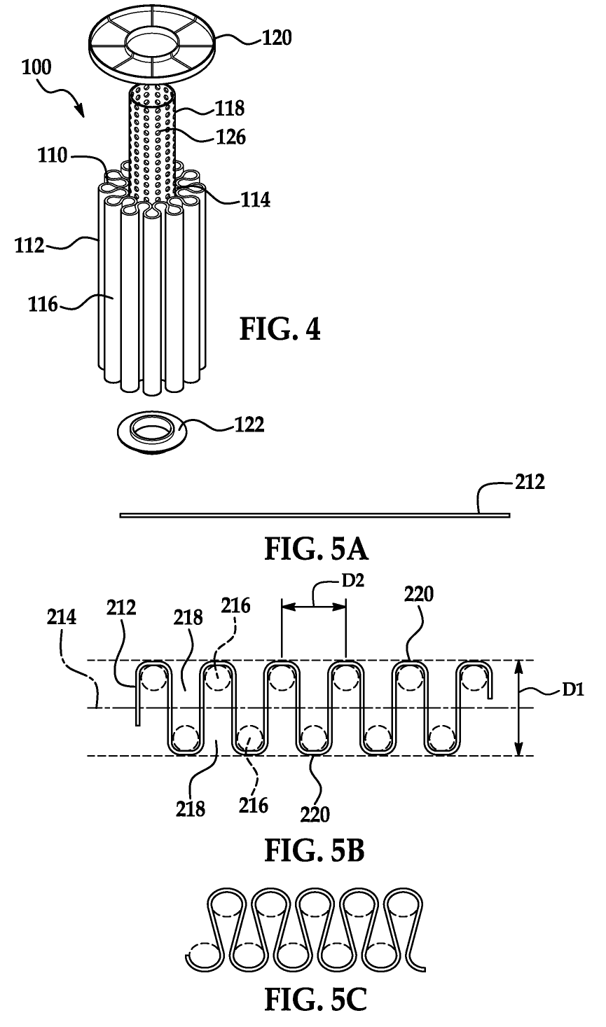

Referring now to FIGS. 5a-5c, an exemplary embodiment of a method of forming a non-woven elongated sheet of ceramic fiber filter media into a high-area pleated is illustrated.

FIG. 5a illustrates an exemplary sheet of ceramic fiber filter media 212 prior to being formed in accordance with the present exemplary embodiment, which will be explained below. In accordance with exemplary embodiments of the present invention, any suitable process may be employed for the formation of the sheet of filter media. For instance, a quantity of ceramic fibers, mixed with a minor quantity of cellulosic fibers, in a liquid carrier, such as water, can be wet-laid onto a screen and the liquid carrier drained or withdrawn from the fibers to define a web, in the nature of a Roto-Former or Fourdrinier papermaking process. Other materials, such as glass fibers and binder resins, may be included. Filter media may include charge modified material, that is, any material that has been treated with a cationic or anionic agent to impart a specific surface charge that is different from the inherent characteristic of the surface prior to treatment or has been chemically modified to target specific moieties. The cellulose fiber may be composed of refined or unrefined pulp. U.S. Pat. No. 6,913,059 (the '059 patent), the contents of which are incorporated herein by reference thereto, is directed to methods of forming a ceramic fiber-based filter medium. In exemplary embodiments of the present invention, aspects of the methods disclosed in the '059 patent can be incorporated into formation of the sheet of filter media. In any event, the process that is chosen results in the deposition of the fibers onto a screen or the like with the fibers that intertangle and intersect neighboring fibers to form a paper-like sheet or mat of ceramic fiber-based web.

In the present exemplary embodiment, as illustrated in FIG. 5b, the ceramic fiber-based sheet is shaped into a series of pleated contours. The pleated contours comprise generally parallel bodies 218 and alternately opposing orbicular heads 216. The orbicular heads have substantially similar diameters and define a series of alternately opposing crests 220. The heights of the pleated contours are substantially similar and defined by the longitudinal distance D1 along the generally parallel bodies of the pleated contours between the alternately opposing crests of adjacent pleated contours.

In exemplary embodiments, the diameters of the orbicular heads may be as large as desired. An increase in the diameter selected for the heads of the pleated contours results in an increase in the area of filtration within a given volume of filter unit housing utilizing the pleated media. Thus, filter units containing filter media having a pleated geometry in accordance with exemplary embodiments of the present invention are attractive for inclusion in those applications in which there are size restrictions.

Upon formation of the sheet into the pleated contours as illustrated in FIG. 5b, the approximate midpoints of the heights of the pleated contours define a center axis 214 along the transverse span of the series of pleated contours. At this point, juxtaposing orbicular heads of the pleated contours on each side of the center axis (that is, orbicular heads situated adjacently either above or below the center axis and facing the same direction) are separated by substantially similar transverse offset distances D2 that are generally parallel to the center axis.

In the present exemplary embodiment, following formation of the pleated contours, the transverse offset distances between the juxtaposing orbicular heads of the pleated contours on each side of the center axis are decreased, thus compressing the bodies of the pleated contours laterally along the center axis while retaining the orbicular heads. At this point, as illustrated in FIG. 5c, the series of pleated contours has been condensed into a series of alternately opposing convex saddles having bodies truncated at root portions by the juxtaposition of the orbicular heads of the immediately anterior and posterior pleated contours along the center axis, as described above in relation to the exemplary embodiment of FIG. 1.

In accordance an exemplary embodiment of the present invention, a method is also provided for successively forming a continuous sheet of ceramic fiber filter media into a high-area pleated geometry. Exemplary embodiments of this method involve first and second serially arranged stages that can occur simultaneously, as in a pipeline. In the first stage, a ceramic fiber-based web, in the form of an elongated sheet, is, beginning with a front end, successively shaped into a series of pleated contours having generally parallel bodies and alternately opposing orbicular heads. In the second stage, the transverse offset distances between the juxtaposing orbicular heads of the pleated contours formed in the first stage on each side of the center axis are sequentially decreased. During the second stage, the series of pleated contours is successively condensed into a series of alternately opposing convex saddles each truncated by the juxtaposition of the orbicular heads of the immediately anterior and posterior pleated contours along the center axis.

The exemplary methods described above need not rely on media stiffness to fold and crease the media and hence may be used to form less pliable media into a pleated geometry as described. Because the filter media is partially condensed and folded, the longitudinal bending stresses that act perpendicularly to the opposing crests of pleated media are reduced. This allows for a ceramic fiber-based web to be pleated without tearing the web or substantially increasing its solidarity. The exemplary methods can also allow much shorter pleats to be formed, as well as faster pleating, without damaging the media or breaking the fibers.

Pleated media formed in accordance with the exemplary pleating methods described above can, for instance, be cut to a prescribed length or prescribed number of pleats as determined by the intended dimensions of a diesel particulate filter. The shape of the pleated geometry can be maintained using any suitable measures, which can be as simple as tying a string about the girth of a bundle of the pleated sheet. Once dried, the pleated sheet retains its shape sufficiently for further processing thereof. In exemplary embodiments, a coating (for instance, silicon carbide) can then be applied to the pleated filter media using a conventional chemical vapor deposition process. Such a coating may serve to coat haphazardly arranged ceramic fibers, as well as the junctions or intersections between the fibers, thereby increasing the strength and durability of the media so that the pleated geometry is maintained. Exemplary embodiments of pleated filter media formed in accordance with the present invention are also suitable for the addition of catalytic materials to improve reaction.

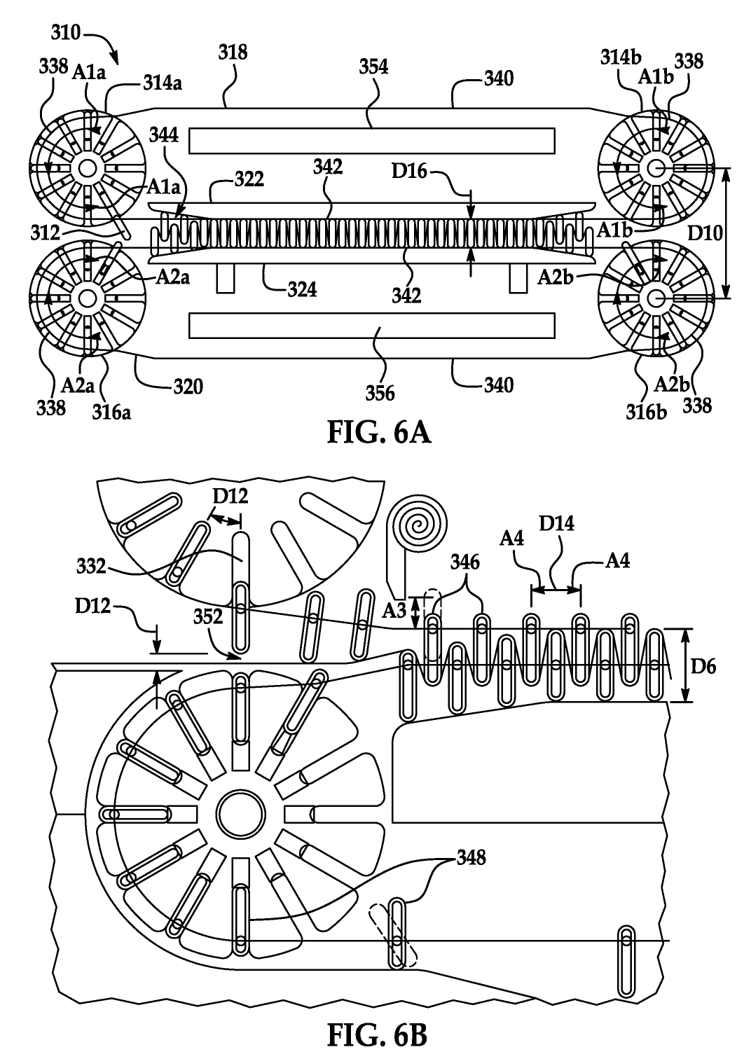

Referring now to FIGS. 6a and 6b, an exemplary embodiment of a forming apparatus for successively forming a continuous sheet of ceramic fiber filter media into a high-area pleat design is illustrated. The exemplary forming apparatus, indicated generally by 310, implements a suitable process for configuring and shaping fiber-based filter media into the pleated geometry. The exemplary apparatus is configured to consistently produce pleats of a predetermined size and includes a plurality of elongated pleating fingers 312, first and second pairs of elongated cylindrical rollers 314, 316, first and second endless conveyor tracks 318, 320, and first and second cam guides 322, 324.

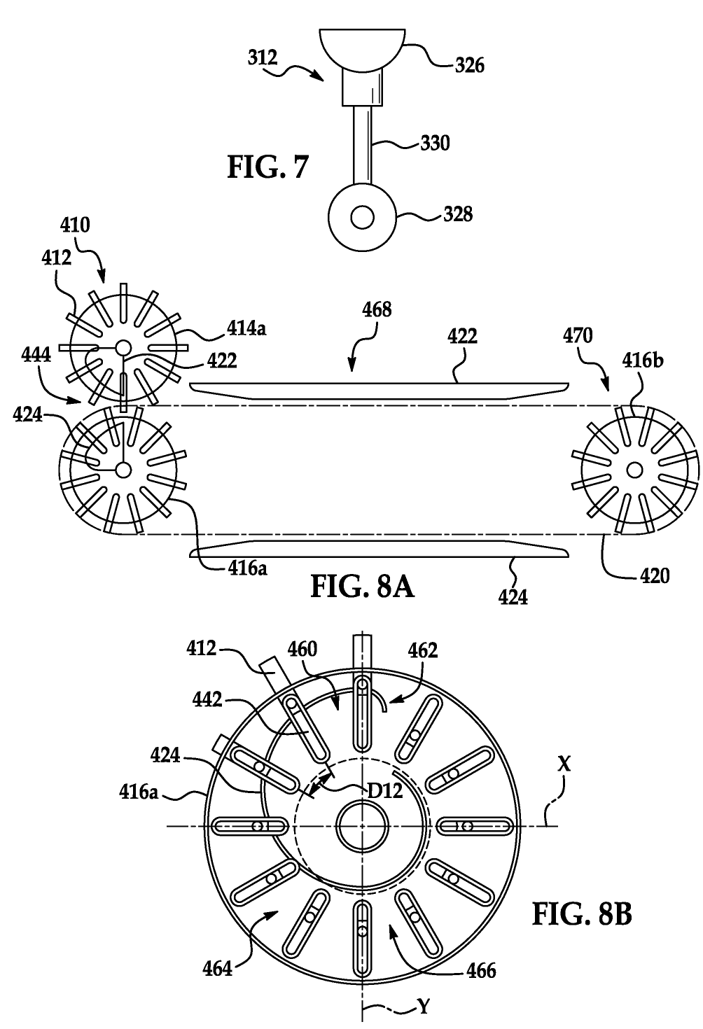

In the present exemplary embodiment, as illustrated in greater detail in FIG. 7, each of the pleating fingers has a proximal end 326, a distal end 328 defined by a cross-sectional orbicular head, and a body 330 disposed between the proximal end and the distal end that is narrower the breadth of the orbicular head of the distal end.

The first pair of rollers, a first front roller 314a and a first back roller 314b, rotate counterclockwise about the rotation axes of the first pair of rollers, as shown by arrows A1a and A1b in FIG. 6a. The second pair of rollers, a second front roller 316a and a second back roller 316b, rotate clockwise about the rotation axes of the second pair of rollers, as shown by arrows A2a and A2b. In exemplary embodiments, the mechanism for driving the rollers can be an electric motor or other suitable drive unit mechanism (not shown). The first and second pairs of rollers are configured to rotate at a generally synchronous rate. The axes of the first pair of rollers run generally parallel to the axes of the second pair of rollers. The longitudinal distance between the axes of the two pairs of rollers is designated by D10.

As shown in the exemplary embodiment of FIGS. 6a and 6b, the rollers may have profiles of the same geometry. Each roller of the first and second pairs of rollers has a plurality of pivot channels 332 extending radially from its circumference toward its axis. The pivot channels of each roller are configured to retain the proximal end of a pleating finger and are spaced at substantially similar circumferential offset distances D12 from one another.

In the present exemplary embodiment, the first and second elongated endless conveyor tracks are supportively disposed around the first and second pairs of rollers respectively, much like the crawler tracks used on a bulldozer. Thus, the first and second conveyor tracks are configured to progress linearly in a likewise direction at a generally constant rate and follow generally parallel endless paths. In exemplary embodiments, the tracks can comprise flexible belts. By “flexible,” it is meant that the belt can be bent or deflected orthogonal to the direction of progression so that the belt can assume the 360-degree endless path.

The endless paths followed by the conveyor tracks include curved segments 338 at each of the corresponding rollers, outer straight segments between 340 each of the corresponding pair of rollers, and inner straight segments 342 between each of the corresponding pair of rollers. The inner straight segments are proximate one another and separated by a generally constant distance perpendicular to the direction of progression.

The first and second cam guides are disposed in the pleating region on opposite sides of the first and second conveyor tracks respectively and are generally parallel to one another and the direction of progression. The first and second cam guides define a lateral pleating region, indicated generally as 344 in the exemplary embodiment of FIG. 6a.

The plurality of pleating fingers includes first and second series of pleating fingers 346, 348. The proximal ends of the pleating fingers of the first and second series of pleating fingers are movably disposed on and alternately staggered at spaced intervals along the first and second conveyor tracks respectively. The pleating fingers can be adjustable at their proximal ends in a direction perpendicular to the conveyor tracks and the direction of motion, that is, the point of connection between a pleating finger and a conveyor track can be varied along the proximal end, as indicated by arrows A3 in FIG. 6b. The pleating fingers can be disposed on the conveyor tracks such that the Thus, the corresponding pleating fingers move in the direction of progression and the bodies of successive pleating fingers alternately extend from the first and second conveyor tracks in successively opposed directions perpendicular to the direction of progression.

In the present exemplary embodiment, as shown in FIG. 6b, when progressing from a straight segment into and through the curved segments of a conveyor track, the pleating fingers imbed in the pivot channels of the rollers. As the pleating fingers advance along the conveyor tracks from a curved segment into a straight segment (for example, into an inner straight segment of the pleating region), the pleating fingers withdraw from the pivot channels.

After withdrawing from the pivot channels of the first and second front rollers, the first and second series of pleating fingers enter the pleating region in an open spaced relationship. When the pleating fingers are disposed in such a relationship, there is a generally constant transverse offset distance along the direction of progression between the distal ends of successive pleating fingers and a longitudinal distance D14 between the orbicular heads of the alternately opposing distal ends of successive pleating fingers. The longitudinal distance defines a longitudinal lane 352 having a generally constant width.

In the present exemplary embodiment, as the pleating fingers progress through the pleating region, the first and second cam guides respectively extend the first and second series of pleating fingers in alternately opposing directions generally perpendicular to the direction of progression. The conveyor tracks maintain the pleating fingers in parallel alignment. More specifically, the cam guides engage the proximal ends of the pleating fingers and actuate the first and second series of pleating fingers to a predetermined traversing position at which the peripheries of the alternately opposing distal ends of successive pleating fingers have at least longitudinally traversed. As shown in the exemplary embodiment of FIGS. 6a and 6b, the height of the pleating fingers D116 is less than the generally constant distance perpendicular to the direction of progression between the inner straight segments. That is, the longitudinal distance between the axes of the first and second pairs of rollers is sufficient to permit each series of pleating fingers to pass through the pleating region without contacting the opposing conveyor track when in the fully extended position.

In exemplary embodiments, the pleating fingers can be disposed on the conveyor tracks such that the transverse distance D14 between adjacent fingers disposed on the same track can be adjusted as indicated by arrows A4, or in the opposite direction from the arrows. That is, the pleating fingers can also be adjustable at their proximal ends in a direction parallel to the conveyor tracks and to the direction of motion. Thus, the offset distances between successive pleating fingers can be adjusted to increase or decrease. For example, the offset distance between successive pleating fingers can be decreased in a back stage of the pleating region. More specifically, the successive pleating fingers can be actuated to an overlapping position at which the body of each pleating finger is adjacent to both the opposing distal end of the immediately preceding pleating finger and the opposing distal end of the immediately succeeding pleating finger.

During operation of the exemplary forming apparatus of FIGS. 6a and 6b, a continuous sheet of ceramic fiber-based filter media is successively fed into the forming apparatus between the two front rollers from a guide table (not shown). Because ceramic fiber-based filter media can be deleteriously abrasive to a pleating machine, the ceramic fiber sheet can be sandwiched between opposing sheets of a kraft (butcher type) paper prior to feeding the sheet into the forming apparatus to reduce abrasion. These sheets of kraft paper can later be removed prior to further processing of the pleated media.

In exemplary embodiments, continuous sheet may be provided from a roll of the media to the guide table. The guide table can include one or more guides such as rails, edges, rollers, or other aligning devices that guide the sheet into the apparatus in a desired orientation. The guide table can also include one or more detection devices, such as optical sensors or cameras, for detecting the position, size, features, and the like of the sheet to determine if the sheet is defective or improperly aligned.

During operation of the exemplary forming apparatus of FIGS. 6a and 6b, a sheet of filter media is continuously advanced into and through the pleating region. The continuous sheet is successively fed, along the direction of progression, into the longitudinal lane formed between alternately opposing pleating fingers as they withdraw from the rollers at the front of the pleating region. As a result, an unformed portion of the sheet continuously progresses into the pleating region between the alternately opposing distal ends of successive pleating fingers. The width of the longitudinal lane between the alternately opposing distal ends of successive pleating fingers in the front stage is greater than the thickness of the sheet.

As the continuous sheet successively advances through the pleating region, the proximal ends of the pleating fingers engage with the slope of the cam guides, which actuate the pleating fingers in successively opposed directions. As a result, the pleating action begins as the extending pleating fingers successively engage the sheet. The continuous sheet is thereby successively shaped into series of pleated contours extending perpendicularly to the direction of progression. As the sheet progresses from the pleating region, it is successively advanced from the apparatus in the pleated form through an outlet region between the two back rollers.

The pleated contours formed in the pleating region have generally parallel bodies and alternately opposing crests that are defined by the orbicular heads of the engaging pleating fingers. The pleated contours are also formed with substantially similar heights defined by the longitudinal distance between the alternately opposing crests of adjacent pleated contours. Prior to operation, the cam guides can be adjusted to extend the pleating fingers to a predetermined traversing position in the pleating region, thereby affecting the lengths of the pleated contours formed in the sheet.

In exemplary embodiments, as the continuous sheet is successively advanced through the pleating region, the series of pleated contours can be sequentially formed into a series of alternately opposing convex saddles by decreasing the transverse offset distance between successive pleating fingers, as described above. More specifically, by decreasing the transverse offset distance along the direction of progression between of successive pleating fingers that engage the pleated contours, the bodies of the pleated contours are successively compressed along the direction of motion in relation to the decreasing transverse offset distance, and the series of pleated contours is thereby condenses into a series of alternately opposing convex saddles each truncated by the juxtaposition of the orbicular heads of the immediately preceding and succeeding pleated contours along the direction of motion.

In exemplary embodiments, the forming apparatus of FIG. 6a can also include heating elements 354, 356 for heating the sheet to a forming temperature and removing the remaining water or carrier. The heating elements can be selected and configured according to the pleated filter media that is to be formed. For example, the heating elements can be disposed in the pleating region so that the sheet is heated before, during, or after forming. The heating elements can comprise any type of heating device, including an electrical resistance heater, an induction heater, or a gas furnace.

The amount of heat provided by the heating elements can be adjustable according to the type, size, and material properties of the sheet of ceramic fiber filter media, the rate at which the sheet is advanced through the heater, the specific dimensions of the pleated geometry that is to be performed, and the like. The heat treatment can be carried out at a sufficient temperature and for a sufficient time to stabilize the filter and to volatize organics in the web (for example, cellulosic fibers), leaving a completed pleated filter medium. Further, although the heating elements are shown as separate devices from the cam guides of the apparatus, the heaters can be part of those or other portions of the apparatus.

Referring now to FIGS. 8a and 8b, an alternative exemplary embodiment of a forming apparatus for successively forming a continuous sheet of ceramic fiber filter media into a pleated geometry is illustrated. This exemplary forming apparatus, indicated generally by 410 in FIG. 8a, is arranged similarly to exemplary forming apparatus 310 of FIGS. 6a and 6b, in that it comprises a plurality of elongated pleating fingers 412 and a first pair of elongated cylindrical rollers 416a. Rather than a second pair of rollers, however, forming apparatus 410 includes a first elongated cylindrical front roller 414a that is substantially aligned with second front roller 416a. The present exemplary embodiment also substitutes a linked chain 420 for the first and second endless conveyor tracks of the embodiment shown in FIG. 6a. As a result, rather than being disposed on and conveyed by tracks, the pleating fingers remain movably imbedded within the pivot channels 442 of first and second front rollers 414a, 416a.

Further, as illustrated in FIG. 8a, the first and second cam guides are replaced by first and second cam wheels 422, 424 respectively disposed on the first and second front rollers. As a ceramic filter medium is continuously introduced into the longitudinal region between the first and second front rollers, the first and second cam wheels operate to actuate the pleating action by respectively extending and retracting the first and second series of pleating fingers from the rotating pivot channels.

In the present exemplary embodiment, the pleating action performed by forming apparatus 410 can be described by dividing each front roller into four quadrants: an inner front quadrant 460, an inner rear quadrant 462, an outer front quadrant 464, and an outer rear quadrant 466, as shown separated by axes X and Y in FIG. 8b. While rotating within the rollers through the outer two quadrants, each pleating finger is fully imbedded within its respective pivot channel. As the pleating fingers rotate through the inner front quadrants, the cam wheels operate to extend the pleating fingers perpendicularly to the direction of motion until the pleating fingers reach axis Y between the front quadrants and the rear quadrants, at which point the pleating fingers are fully extended.

Because the rotation of the first front roller is radially offset from that of the second front roller by a length that is substantially equivalent to half the circumferential offset distance D12 between the pivot channels in each front roller separately, the action of the cam wheels serve to alternately extend opposing pleating fingers into a sheet as it is continuously fed between the front rollers.

More specifically, as the continuous sheet successively advances through a forming region 444, defined as the longitudinal region between the two front rollers, the proximal ends of the pleating fingers engage with the slope of the cam wheels, which actuate the pleating fingers in successively opposed directions. As a result, the pleating action begins as the distal ends of the extending pleating fingers successively engage the sheet. The continuous sheet is thereby successively shaped into series of pleated contours extending perpendicularly to the direction of progression. The pleated contours formed in the forming region have generally parallel bodies and alternately opposing crests that are defined by the orbicular heads of the engaging pleating fingers. The pleated contours are also formed with substantially similar heights defined by the longitudinal distance between the alternately opposing crests of adjacent pleated contours. Prior to operation, the cam wheels can be adjusted to extend the pleating fingers to a predetermined full extension position, thereby affecting the lengths of the pleated contours formed in the sheet.

In the present exemplary embodiment, as the pleating fingers rotate into and through the inner rear quadrants of the front rollers, the cam wheels actuate retraction of the pleating fingers perpendicularly from the direction of motion until the pleating fingers fully disengage from the continuously advancing sheet and imbed in the pivot channels. At this point, the present exemplary forming apparatus transfers the pleated media from the forming region into a heat-treating region 468 between first and second guide rails 422, 424 on opposing sides of the linked chain. The linked chain then operates to convey the pleated media through the heat-treating region between the front rollers and the back roller. In this region, heating elements are provided for heating the sheet to a forming temperature and removing the remaining water or carrier as the sheet is conveyed between the guide rails.

Thus, as shown in the exemplary embodiment of FIG. 8a, the continuous sheet is successively shaped into series of pleated contours extending perpendicularly to the direction of progression in a forming region adjacent to the front rollers, and then passed through a heat-treating region between the front rollers. As the sheet progresses from the heat-treating region, it is successively advanced as a series of pleated contours through and out from an outlet region 470 proximate to the back roller.

Once received from the outlet region, the series of pleated contours can be sequentially formed into a series of alternately opposing convex saddles by decreasing the transverse offset distance between successive pleating fingers. This may be accomplished, for example, by pinching or compressing the bodies of the pleated contours laterally along the center axis while retaining the orbicular heads. This will serve to condense the series of pleated contours into a series of alternately opposing convex saddles having bodies truncated at root portions by the juxtaposition of the orbicular heads of the immediately anterior and posterior pleated contours along the center axis.

The exemplary forming apparatuses described above in relation to FIGS. 6 and 8 can be used to form a pleated geometry while reducing the tensile and compressive forces on the sheet. A reduction in friction can also be achieved. The pleating fingers can be operated to fold and condense the fiber-based filter media without crushing it and without adversely affecting the performance of the final filter product. The overlapping action of the pleating fingers helps to prevent unwanted jams or reverse pleating otherwise common with score-roll pleating. Due to the radial heads of the distal ends of the pleating fingers, the exemplary forming apparatuses need not rely on media stiffness to fold and crease the media, and therefore, may be utilized to form less pliable media into a pleated geometry as described. Because the filter media is partially condensed and folded, the longitudinal bending stresses that act perpendicularly to the opposing crests of pleated media are reduced. This allows for a fiber-based web comprised of fragile ceramic fibers, such as those particularly suited for use in a diesel particulate filter, to be pleated without tearing the web or having to substantially increase its solidarity. The exemplary apparatuses can also be utilized to form much shorter pleats to be formed, as well as for more rapid pleating, without damaging the media or breaking the fibers. Thus, exemplary embodiments of the present invention can diminish the need to use extruded ceramic monoliths for diesel emission control filters.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

1. A ceramic fiber-based filter element having a pleated geometry, the filter element comprising:
an elongated ceramic filter medium disposed circumferentially around a series of alternately opposing convex saddles along an axis, the alternately opposing convex saddles each having a root portion and an orbicular head, the root portion of each alternately opposing convex saddle being truncated by an opposing juxtaposition of the orbicular heads of the immediately anterior and posterior convex saddles along the axis.

2. The filter element of claim 1, wherein the ceramic filter medium comprises a web of fibrous material selected from the group consisting of aluminum oxide, zirconium oxide, silicon dioxide, silicon carbide, aluminum nitride, silicon nitride, cordierite, mullite, and combinations thereof.

3. The filter element of claim 2, wherein the ceramic filter medium further comprises cellulosic fibers.

4. (canceled)

5. (canceled)

6. The filter element of claim 1, wherein the ceramic filter medium comprises a plurality of elongated layers of ceramic filter media.

7. The filter element of claim 1, wherein the ceramic filter medium further comprises a pair of elongated lengthwise edges, wherein the ceramic filter medium is curved into a cylindrical configuration, and wherein the lengthwise edges of the filter medium are sealed to each other along a seam.

8. The filter element of claim 1, wherein the ceramic filter medium further comprises a pair of elongated lengthwise edges and wherein the ceramic filter medium is curved into a helical configuration.

9. A ceramic cylindrical filter module comprising:
a cylindrical ceramic fiber-based filter element having a plurality of pleats, the plurality of pleats including a series of alternately opposing inwardly radiating convex saddles and outwardly radiating convex saddles, the inwardly radiating convex saddles defining an inner periphery of the cylindrical filter element, the outwardly radiating convex saddle defining an outer periphery of the cylindrical filter element, the alternately opposing convex saddles defining a plurality of radially extending elongated channels that run in an axial direction to the cylindrical filter element;
a cylindrical core axially disposed within the inner periphery of the cylindrical filter element; and
a cylindrical outer cage axially disposed on the outer periphery of the cylindrical filter element.

10. The filter module of claim 9, further comprising first and second end caps, the first end cap being disposed on a first lengthwise end of the filter module, the second end cap being disposed on a second lengthwise end of the filter module.

11. The filter module of claim 9, wherein the cylindrical outer cage has a cross-sectional diameter ranging from 200 mm to 325 mm, the cylindrical core has a cross-sectional diameter ranging from 25 mm to 100 mm, and the filter module has a length ranging from 100 mm to 500 mm.

12. (canceled)

13. A method of successively forming a ceramic fiber-based filter element into a pleated geometry comprising:
successively shaping a continuous elongated ceramic filter medium into a series of pleated contours having generally parallel bodies and alternately opposing cross-sectional orbicular heads, the orbicular heads defining alternately opposing crests, the pleated contours having substantially similar heights defined by the longitudinal distance between the alternately opposing crests of successive pleated contours, a set of approximate midpoints of the heights of the pleated contours defining an axis along the transverse span of the series of pleated contours, the juxtaposing orbicular heads of the pleated contours on either side of the axis being separated by substantially similar transverse offset distances; and
sequentially decreasing the transverse offset distances between the juxtaposing orbicular heads of the pleated contours on each opposing side of the axis to successively compress the bodies of the pleated contours laterally along the axis and condense the series of pleated contours into a series of alternately opposing convex saddles, each successive alternately opposing convex saddle converging within an opposing juxtaposition of the orbicular heads of the immediately preceding and succeeding pleated contours along the axis.

14. The method of claim 13, further comprising successively heat-treating the ceramic filter medium while it is being formed.

15. The method of claim 14, further comprising clipping a section of pleated filter medium of a predetermined length from the series of alternately opposing convex saddles, the section of pleated filter medium having first and second lengthwise edges, curving the section of pleated filter medium into a cylindrical shape, sealing the lengthwise edges of the section of pleated filter medium to each other along a seam, and incorporating the section of pleated filter medium into a structural member to define a filter unit.

16. (canceled)

17. (canceled)

18. (canceled)

19. The method of claim 15, further comprising applying a catalyst coating to the section of pleated filter medium.

20. (canceled)

21. (canceled)

22. (canceled)

23. (canceled)

24. (canceled)

25. (canceled)

26. (canceled)

27. (canceled)
